(19) United States
(12) Patent Application Publication
(10) Pub. No.: US 2008/0177569 A1
(43) Pub. Date: Jul. 24, 2008

(54) Mobile Phone Based Authentication and Authorization System and Process to Manage Sensitive Individual Records

(75) Inventors: Liren Chen, San Diego, CA (US); Jack Steenstra, San Diego, CA (US); Kirk Taylor, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/626,769

(22) Filed: Jan. 24, 2007

(51) Int. Cl. G06Q 50/00; H04Q 7/00

(52) U.S. Cl. 705/2; 340/5.8; 370/328

(57) ABSTRACT

Personal health records for a user of a wireless remote station are generated and stored electronically, and access may be provided to an authenticated and authorized individual. The health records may be stored at the remote station, or at a server. An individual requests access to the health records, the identity of the individual is authenticated, and authorization of the individual is verified before providing the health record. The authentication may comprise a biometric identification.

### BACKGROUND

1. Field

The technology of the present application relates generally to accessing personal records, and more specifically to authorizing access to personal records through a mobile telephone.

2. Background

Securing personal information from unauthorized access or release is becoming increasingly important as increasing amounts of information for individuals is stored and managed in an electronic format. Such security becomes even more important with the increasing prevalence of identity and information theft. Such personal information can be very personal and sensitive, such as a person's identity, address, identification numbers, employment information, financial information, credit rating, and medical information. Unauthorized access or release of these types of information can lead to serious social, financial, and/or criminal consequences.

Currently, various different mechanisms are used to manage authentication and authorization of access to personal information. Some of these mechanisms are inherently insecure and may result in undesired persons having access to personal information, and some of these mechanisms may overly inhibit access to such information when needed by some individuals. For example, in the case of personal health records, in the event of a medical emergency an individual having a medical emergency would, for health reasons, generally desire that medical staff attending to the medical emergency have access to relevant medical information of the individual. In some cases, individuals carry a card on then person that lists current medical conditions and also lists current prescription medications that the individual is taking. In the event of a medical emergency, medical personnel may look through the individual's wallet or pocketbook and locate this card, thus obtaining important information needed for proper medical treatment in such a medical emergency. However, the use of such a card may result in undesirable persons having access to this information in the event that the card is seen by the undesired persons. Such an incident may occur, for example, if the person finds a lost wallet or pocketbook, or steals a wallet or pocketbook. This unauthorized person would then have access to this personal health information. Disclosure of information on such a card may also occur inadvertently, such as if the card falls out or is otherwise exposed when the individual is accessing the wallet or pocketbook for some other reason. For a more specific example, an individual may be receiving medical treatment for a condition that, the individual considers to be particularly private, such as a mental health condition. This medical information, along with prescription medications taken for this condition, may be printed on such a card. In the event that such a card is inadvertently exposed to co-workers, for example, the individual's medical condition will also be revealed, which may cause embarrassment or even adverse career consequences for the individual. However, an individual may consider the risk of such exposure as acceptable because of the importance of medical personnel having this information in the event of a health emergency.

Information such as this may be critically important m a health emergency in order to aid in diagnosis of the medical condition, and/or to prevent administration of medication that can have dangerous reactions with the prescription medication. However, medical personnel may not have time to search through a person's belongings to look for such an information card, or the personnel may not think to check for such information. Furthermore, even if medical personnel, search for such a card, it may not be found because the search may be hurried and the card overlooked, or the card may be placed in a location that the medical personnel do not search. Other types of personal information may raise similar concerns. Accordingly, it would be beneficial to have such personal information that is readily accessible by authorized persons, and also secure against access to unauthorized persons.

Additionally, some of the information may require frequent updates. For example, the personal medical information may contain, information regarding the prescription drugs a person is taking. Such, information may be critically important to medical personnel in diagnosing and responding, to a medical emergency. If the information is printed on a card, a new card will have to be printed to replace the previous card each time the person is put on a new medicine, or the prescription is otherwise changed. Such frequent updates to printed cards results, in an inconvenience and a lower compliance rate as a person either does not have a new card printed, or procrastinates obtaining an updated card. Incorrect information from such an outdated card may lead to harmful consequences if medical personnel rely on such obsolete information. Accordingly, it would also be beneficial to have such personal information that is current and requires little or no additional effort by a user to keep current.

### SUMMARY

Embodiments disclosed herein address the above stated needs by providing for the secure storage and access of personal health records. Personal health records are generated, updated, and stored electronically, and access may be provided to an authenticated and authorized individual.

In one aspect a remote station apparatus is provided that comprises a transmit/receive circuit that is operable to transmit/receive signals to/from a wireless communications network; a user interface; and a control processor that authenticates and authorizes a request to access personal health information from the user interface. The control processor provides the personal health information upon authentication and authorization. The control processor may connect to a server through the transmit/receive circuit, authenticate the identification of the person making the request at the server, and obtain authorization from the server for access to the personal health information. The authentication may comprise a biometric identification.

In another aspect a server apparatus is provided that comprises a network interface to transmit/receive signals to/from at least a first wireless remote, station through a wireless network; a control processor operable to receive a request from the first remote station to access personal health information of a user of the first remote station, authenticate an identity of the individual requesting access, verify the individual is authorized to access the personal health information of the user, and provide the personal health information when the individual is authenticated and authorized. The control processor may receive biometric information of the individual requesting access and perform biometric identification of the individual. The personal health information may include a current prescription medication taken by the user and a current medical condition of the user.

In still another aspect a method for providing access to a personal health record through a wireless remote station is provided that comprises the steps of (a) receiving a request from an individual to access a personal health record of a user of the remote station, (b) authenticating the identity of the individual, (c) verifying the individual is authorized to access the personal health record, and (d) providing access to the personal health record when the individual's identity is authenticated and the authorization is verified. The method may also include the steps of (e) prompting the individual to provide biometric information, and (f) receiving the biometric information. The biometric information may be compared to known biometric information for the individual the identity of the individual authenticated when the biometric information matches the known biometric information.

### BRIEF DESCRIPTION OF THE DRAWINGS

FIG. 1 is a block diagram illustration of a wireless communications system of an exemplary embodiment of the disclosure;

FIG. 2 is a block diagram illustration of a remote station of an exemplary embodiment;

FIG. 3 is a block diagram illustration of a base station of an exemplary embodiment;

FIG. 4 is a block diagram illustration of a server of an exemplary embodiment;

FIG. 5 is a flow chart diagram illustrating the operational steps for storing and providing personal health records of an exemplary embodiment;

FIG. 6 is a flow chart diagram illustrating the operational steps for storing personal health records of an exemplary embodiment;

FIG. 7 is a flow chart diagram illustrating the operational steps for storing personal health records of an exemplary embodiment;

FIG. 8 is a flow chart diagram illustrating the operational steps for providing personal health records of an exemplary embodiment;

FIG. 9 is a flow chart diagram illustrating the operational steps for dispatching emergency personnel and providing personal health records to the emergency personnel of an exemplary embodiment; and

FIG. 10 is a flow chart diagram illustrating the operational steps for providing personal health records of an exemplary embodiment.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

The word “biometric identification” is used herein to mean identification of an individual from a measurement of one or more physical features or repeatable actions of the individual. Such physical features or repeatable actions may include, for example, hand geometry, retinal scan, iris scan, fingerprint patterns, facial characteristics, DNA sequence characteristics, voice prints, and hand written signature.

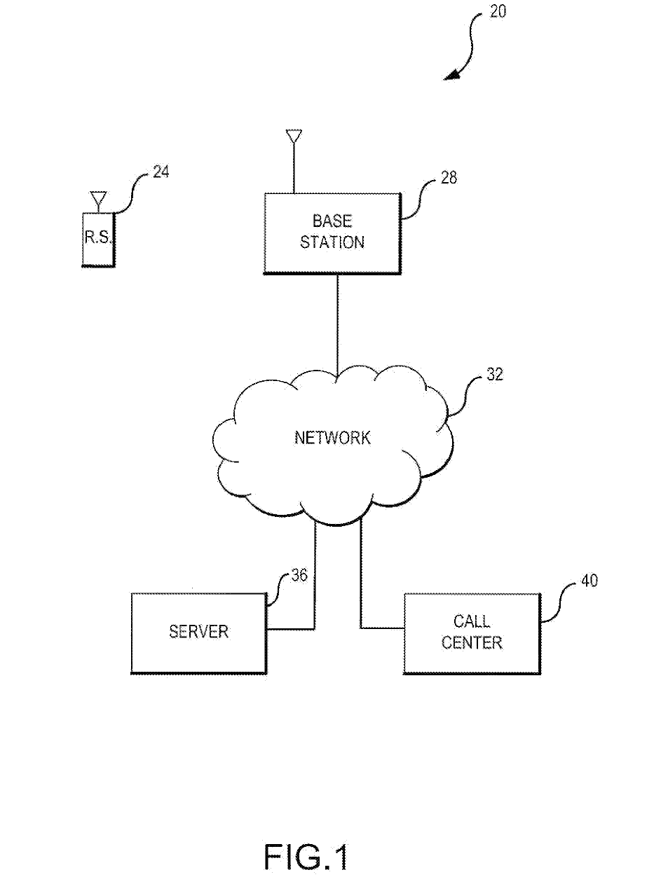

FIG. 1 illustrates a wireless communications network 20 of an exemplary embodiment. In this embodiment, the wireless communications network 20 includes a remote station 24, and a base station 28 that is interconnected to a network 32, which may be a single network or a combination of different networks, such as, for example, the public switched telephone network (PSTN) or the Internet. Also included in this embodiment is a server 36 and call center 40 that are also interconnected to the network 32. The remote station 24, in this embodiment, is a wireless communication device such as a mobile telephone that communicates with base station 28 using one or more of many available wireless protocols such as CDMA, GSM, WiFi, or the like. While the remote station 24 as discussed in many of the embodiments herein is described as a mobile telephone, it will be understood that other devices may also serve as a remote station, such as a personal computer, PDA, digital music player, among others. Furthermore, while a single remote station 24 is illustrated in FIG. 1, it will be understood that a typical wireless communications network 20 will include many remote stations 24 and that a single remote station 24 is illustrated for purposes of a simplified illustration and discussion. The remote station 24 may provide a user with many different functions, one of which is an authentication and authorization function to provide access to personal information of the user. As used herein with reference to a remote station 24, a user is the primary user of the remote station 24, and personal information of the user may be accessed through the remote station 24. Authorized parties are others that may access the remote station 24 and access some or all of the user's personal information. In embodiments described herein, the remote station 24 provides access to personal information to the user and authorized parties and, prior to providing such access authenticates a individual's identity and verifies that the individual is authorized to access the personal information of the remote station 24 user. In this manner, a user of the remote station 24 may access their personal information and other authorized parties may also access some or all of the user's personal information, as will be described in more detail below.

The remote station 24 of the embodiment of FIG. 1 communicates with a base station 28. Such communications may include any available communications protocol, such as CDMA, although any other analog and/or digital communications protocol may also be used. The base station 28 is interconnected with network 32, and communicates with one or more other devices also interconnected with the network 32. While a single base station 28 is illustrated, it will be understood that wireless communications networks 20 typically include many base stations throughout the coverage area of the wireless communications network 20. Server 36, in this embodiment, is interconnected with the network 32, and may provide services and/or information to the remote station 24 related to authenticating, authorizing, and accessing personal information as will be described in more detail below. Call center 40 also is interconnected to the server 36 through network 32 in this embodiment, and may have operators or assistants that may provide services and/or information to the remote station 24, or a user of the remote station 24 related to personal information. While this embodiment illustrates the server 36, call center 40, and base station 28 as separate items on the network 32, it will be understood that the functions of one or more of these items may be incorporated or co-located with one or more other items. Furthermore, while this embodiment illustrates a wireless communications network, the principles described also apply to traditional wired communications networks, in which a user terminal of the network would provide access to personal information.

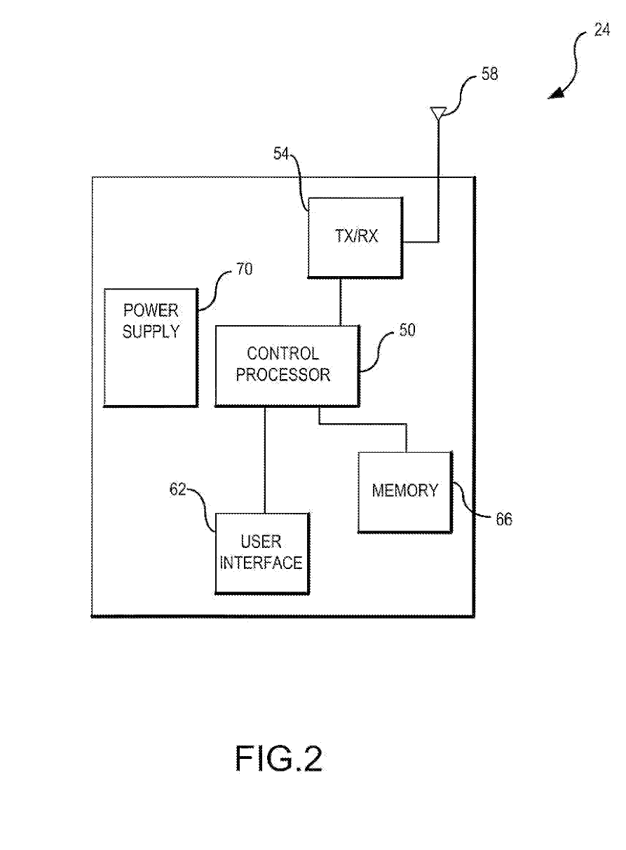

With reference now to FIG. 2, a remote station 24 of an exemplary embodiment is described in more detail. The remote, station 24 includes several components, including a control processor 50. The control processor 50 controls functions, of the remote station 24, and provides computing functionality to process many inputs and/or data as may be required for the operation of the remote station 24. Connected to the control processor 50 is transmit/receive circuitry 54 that transmits/receives wireless signals to/from an antenna 58. The transmit/receive circuitry 54 performs functions typical of such components as used in wireless communications, such as modulating signals received from the control processor 50 that are to be transmitted over the antenna 58, and demodulating signals received from the antenna 58 and providing the demodulated signals to the control processor 50. The antenna 58 may be any antenna suitable for wireless communications in the wireless communications network 20, and while illustrated as a single antenna, may include one or more different send and receive antennas. A user interface 62 is interconnected with the control processor 50, and provides an audio, visual, and/or physical interface to a user. Such user interfaces 62 commonly include a speaker, microphone, visual display screen, and one or more physical input devices such as a keypad, trackwheel, and/or special input buttons that control speaker/ringer volume, etc. The user interface 62 also may include a biometric identification input that collects biometric information for use in authenticating the identity of an individual. The control processor, in this embodiment, also is interconnected with a memory 66, which may be used to store processing instructions to be executed by the control processor 50. The memory 66 also may store data necessary or convenient for the operation of the remote station 24, such as data relating to one or more base stations, network timing information, and a directory of user contacts, to name but a few. Such memory 66 may include, volatile and/or nonvolatile memory on any suitable storage media. In various exemplary embodiments described herein, the memory 66 is used to store personal information and authentication information for one or more individuals that are authorized to access the personal information. Such authentication and authorization are discussed in more detail below. The remote station 24 also includes a power supply 70 that may include one or more rechargeable batteries and an interface to an external power source. Furthermore, while not illustrated in FIG. 2, many remote stations include additional components such as, for example, cable interfaces that allow the remote station to be interconnected with other computing devices, short range wireless transmitters/receivers such as BLUETOOTH technology devices, and/or CCD arrays for digital imaging.

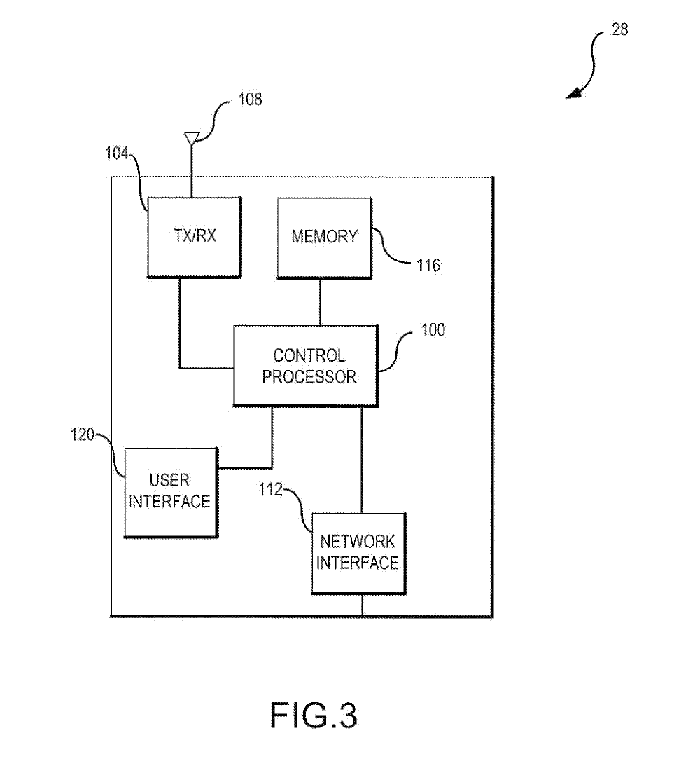

FIG. 3 is a block diagram illustration of a base station of an exemplary embodiment. In this embodiment, the base station 28 includes a control processor 100 that is interconnected to a transmit/receive subsystem 104 and antenna subsystem 108. The transmit/receive, subsystem 104 provides capability to transmit/receive wireless communications to/from various different remote stations and/or other base stations. Furthermore, the transmit/receive subsystem 104 may provide communications with one or more satellites. The antenna subsystem 108 may include one or more different transmit and receive antennas, and may include different antennas for communications with different devices or with different communication protocols. A network interface 112 is interconnected to the control processor 100, and provides an interface to network 32 (FIG. 1). A memory 116 is interconnected to the control processor 100, and may store processing instructions to be executed by the control processor 100. The memory 116 also may store data necessary or convenient for the operation of the base station 28, such as data relating to one or more other base stations, data relating to one or more remote stations within range of the base station 28, network timing information, and a directory of adjacent base stations, to name but a few. Such memory 116 may include volatile and/or nonvolatile memory on any suitable storage media. The base station 28 also includes a user interface 120, which may be used by network personnel to interface with the base station 28.

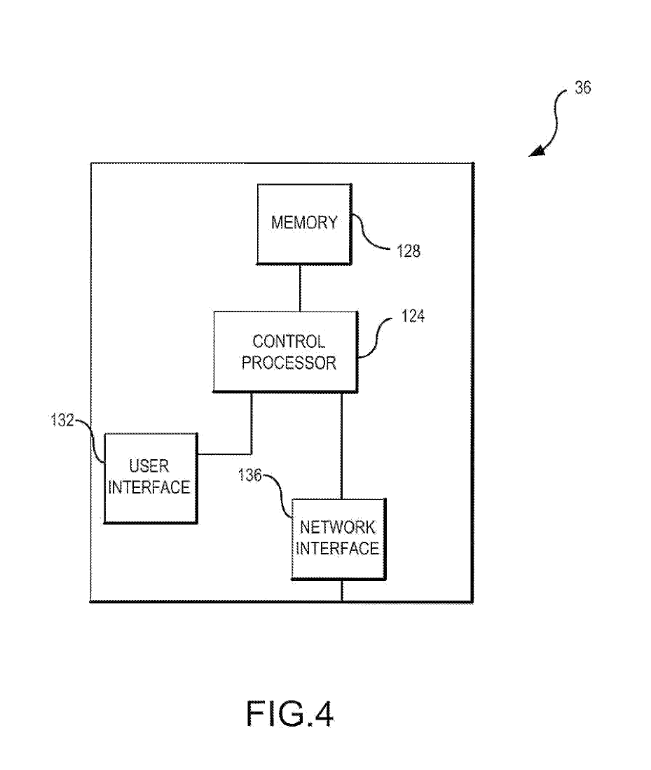

FIG. 4 is a block diagram illustration of a server of an exemplary embodiment. In this embodiment, the server 36 includes a control processor 124 that is interconnected to a memory 128, user interface 132, and a network interface 136. The memory 128 is used to store processing instructions to be executed by the control processor 124. The memory 128 also may store data necessary or convenient for the operation of the server, such as data relating authorized individuals that may access personal information of various users and authentication information associated with the authorized individuals. In one embodiment, the server 36 is also associated with a database containing information related to individuals, access rights of the individuals, and authentication information for each of the individuals. Such memory 116 may include volatile and/or nonvolatile memory on any suitable storage media. The user interface 132 provides an interface for appropriate personnel to interface with the server 36. The network interlace 136 provides an interface between the server 36 and the network 32 (FIG. 1). In one embodiment, personnel at the call center 40 (FIG. 1) access application programs of the server 36 and may use such applications to manage authentication and authorization information for individuals.

As discussed briefly above, various exemplary embodiments described herein provide a remote station that communicates with a server to authenticate and authorize individuals to access personal information. Although the remote station could authenticate and authorize individuals locally as a matter of design choice. Authenticating and authorizing access to information through the remote station provides enhanced access to such information and provides enhanced security of such information. For example, a user of the remote station may have medical information such as a medical condition and/or current prescribed medications that may be used by medical personnel for important treatment decisions in the event of a medical emergency. In such a case, the user may have access to the medical information, referred to as a personal health record, as well as authorized medical personnel. In various embodiments herein, authorized medical personnel may provide authentication information to the remote station, with the remote station, in response thereto, providing access to the personal health record of the user. Further embodiments herein provide for the entry, storage, and modification of personal health records to ensure that such a personal health record is up to date. Any of the remote station, a base station, a call center, a server, or some combination thereof may determine whether any individual is authenticated and authorized to access the information. While several exemplary embodiments are described herein with reference to personal health records, it will be understood that the principles described also apply to other types of personal information other than personal health records, such as, for example, financial information.

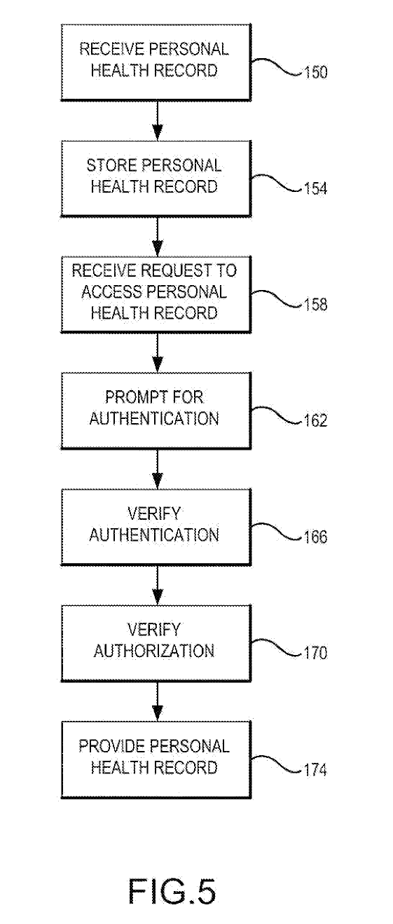

Referring now to FIG. 5, the general operational steps for management and access of a personal health record are now described for an exemplary embodiment. These steps may be performed at a remote station, at a server, or a combination of both. In this embodiment, the personal health record is received, as indicated at block 150. The personal health record may be received by a user entering information into a remote station or entering information into a server that the user has access to. The personal health record may also be entered by a medical service provider or by another service provider that has authorization to manage such information for the user. Entering the personal health record by a service provider may require separate authentication and authorization. At block 154, the personal health record, is stored. The personal health record may be stored at the remote station, at a server, or at both. At block 158, a request to access the personal health record is received. Such an access request may come from the user who desires to view and/or modify their information, from a service provider who has authorization to access this information, and/or from emergency medical personnel who need the information to properly diagnose and treat the user in the event of a medical emergency. At block 162, the individual who requested access to the personal health record is prompted for authentication. The authentication, in one exemplary embodiment, is a biometric identification of the individual who requested access. At block 166, the authentication is verified. Such verification may include verifying the biometric identification of the individual who requested access against stored biometric identification information for that individual. At block 170, authorization is verified to ensure the individual requesting access to the personal health record is authorized to access, this information. Such authorization may be granted by the user to certain individuals, such as a health care provider or a spouse. Such authorization also may be granted to registered emergency medical personnel. When authorization is granted to registered emergency medical personnel, such personnel may be registered, for example, with a service that provides such authentication and authorization. Furthermore, authorization may be granted to an organization, such as a network of health care providers. Authorization may also be granted based on access time, such as authorizing access to certain persons, only during business hours. Authorization may also be usage based such as a limited number of accesses before requiring re-authorization, or a one time access per preset time period. As mentioned above, steps such as authentication and authorization verification may be combined. At block 174, the personal health record is provided to the individual that requested the information. The creation of a personal health record, as well as authentication and authorization prior to access of such information, will be described in more detail below with reference to several exemplary embodiments.

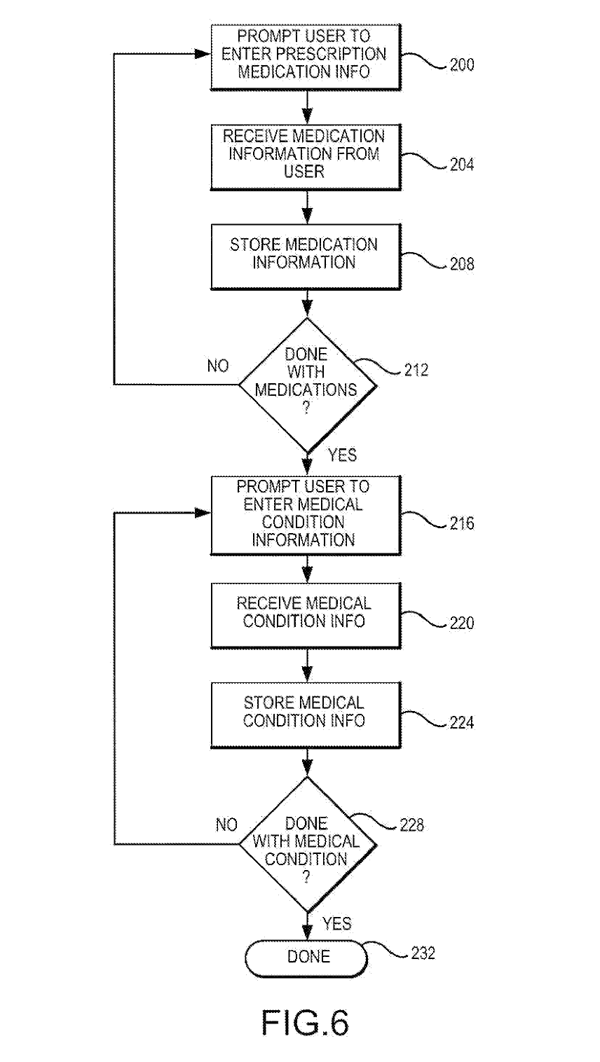

Referring now to FIG. 6, the operational steps for entry of a personal health record at a remote station are now described for an exemplary embodiment. The entry of such information may be initiated after the authentication and authorization of the individual who is entering the information. The individual may be the user who is entering their own information, or an individual authorized to manage this information for the user. In this embodiment, the remote station prompts the user to enter prescription medication information, as indicated at block 200. The prompt for the entry of medication information may include, for example, an entry field for the user to input the medication, or a listing of medications from which a user may select their medication. Such a listing may be arranged in any suitable manner to provide for selection of the medication, such as alphabetically or grouped by conditions that the medication is taken for, to name but two examples. The remote station may store all of the information necessary to prompt the user to enter prescription medication information, or may interact with a server to receive some of all of the information necessary to prompt the user. At block 204, medication information is received, and this information is stored according to block 208. The information may be stored locally at the remote station memory, and/or may be transmitted to the server for storage. At block 212, the user is prompted regarding additional medications that need to be entered. If there are more medications to be entered, the operations of blocks 200 through 212 are repeated.

If it is determined at block 212 that all medications have been entered, the remote station may prompt the user to enter medical condition information, as noted at block 216. The prompt may include, for example, an entry field for the user to input the medical condition, or may include a listing of conditions from which the user may select appropriate conditions. Such a listing may be arranged in any suitable manner to provide for selection of the condition, such as alphabetically or by grouped by categories of conditions, to name but two examples. The remote station may store all of the information necessary to prompt the user to enter medical condition information, or may interact with a server to receive some or all of the information necessary to prompt the user. At block 220, medical condition information is received, and this information is stored according to block 224. The information may be stored locally at the remote station memory, and/or may be transmitted to the server for storage. At block 228, the user is prompted regarding additional medical conditions that need to be entered. If there are more medical conditions to be entered, the operations of blocks 216 through 228 are repeated. If it is determined at block 228 that all of the medical condition information has been entered, the operations are completed, as indicated at block 232, and the personal health record is considered to be complete. In some embodiments, additional information also is included in the personal health record, such as, for example, identification and residence address information of the user, people to contact in the event of an emergency along with their contact information, and primary physician information, to name, but a few. Such information may be entered into the personal health record in a similar manner as medication and medical condition information. In addition, the personal health information may be manually input from an alternative interface such as a website that is integrated, with the server and database, or automatically integrated with another information system such as a pharmacy prescription management system or a hospital medical system.

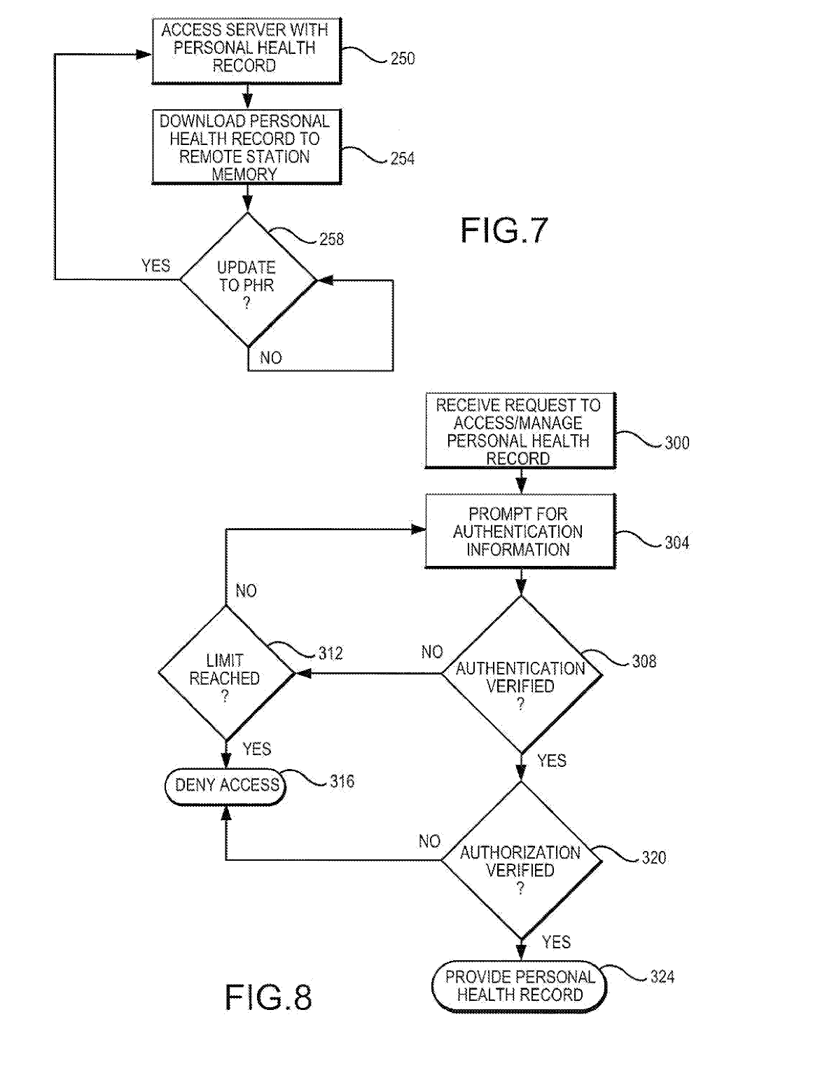

In another exemplary embodiment, the remote station accesses a server to obtain a personal health record of the user of the remote station. In this embodiment, the personal health record may be generated, updated, and stored at the server by, for example, a health provider or other service provider that has authorization to manage such information. The operational steps for this embodiment are illustrated in FIG. 7. In this example, the remote station accesses a server with the personal health record, at noted at block 250. At block 254, the personal hearth record is downloaded to the remote station memory and stored for future access, if required. At block 258, it is determined if the personal health record has been modified or updated, if such a modification or update has occurred, the operations of blocks 250 through 254 are repeated. Such an update or modification may occur, for example, as a result of the user being diagnosed with another medical condition, prescribed a different prescription medication, and/or change in contact information, to name but a few. In the event of such a change, in one embodiment the server pushes a notification to the remote station that such an update has occurred, with the remote station then accessing the server to download the changed personal health record. In some other exemplary embodiments, the remote station may periodically query the server to determine if any changes have occurred, the user may cause the remote station to obtain the changed record, a service provider may cause the remote station access the server to retrieve the record.

Referring now to FIG. 8, the operational steps of authentication and authorization for an exemplary embodiment are described. In this embodiment, a request to access and/or manage the personal health record is received at the remote station, as indicated at block 300. The remote station, at block 304, prompts the requestor for authentication information. Such authentication information may include biometric identification that is entered into the remote station. For example, after receiving a request, to access the personal health record, the remote station may prompt the requestor for identification and to press their finger to a biometric sensor of the remote station that determines relevant physical characteristics of the finger. As will he understood, this is simply one example of biometric information, and the remote station may prompt for any of a number of physical features of repeatable actions of the requestor. In some embodiments the remote station includes a biometric sensor that collects biometric information. In other embodiments, such biometric information may be collected by remote station components that are not simply biometric sensors, but also have other functions for the remote station, such as a CCD array that is used to capture digital images at the remote station. Such a sensor may be used to image the requestor and this image used in biometric identification. In other embodiments, the biometric identification may be a voice print of the requestor that is spoken into a microphone in the user interface, in which case a separate biometric sensor is not required. At block 308, it is determined if the authentication is verified. This may be accomplished using any of a number of verification techniques, such as by comparing the biometric information of the requestor against previously stored biometric information for the identified individual. Such a determination may be performed at the remote station, or the remote station may communicate the request, identification and biometric information to a server where a biometric identification can be verified. If, at block 308, authentication is not verified, it is determined if a request limit has been reached for this particular requestor, as noted at block 312. If the request limit is not reached, the operations of block 304 are repeated. If the request limit has been reached at block 312, access is denied at block 316. If at block 308, authentication is verified, it is determined at block 320 if the requestor is authorized to access the personal health record of the user. Such a determination may be performed at the remote, station, or at the server. If the requestor is not authorized to access this information, access is denied at block 316. If the requestor is authorized to access this information, the personal health record is provided according to block 324. The personal health record may be provided by the remote station, in the event that the remote station has the personal health record stored, or the server may provide the personal health record to the remote station that then provides the information to the requestor.

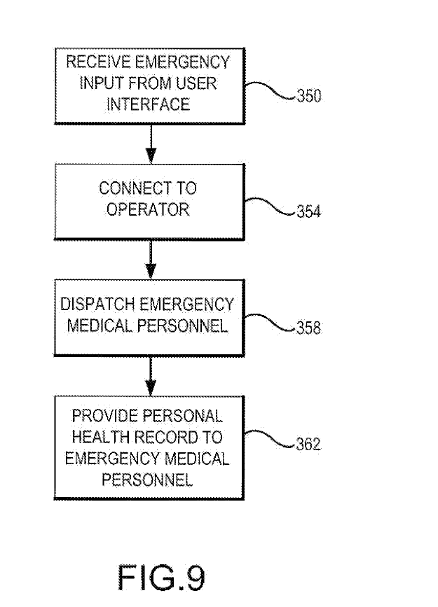

While many of the exemplary embodiments discussed above are described in terms of an individual requesting access to a personal health record, through a remote station, other exemplary embodiments may provide such information automatically to specified individuals in certain events. One such exemplary embodiment is described with respect to FIG. 9. In this embodiment, a remote station receives an emergency input at the user interface, as noted at block 350. Such an emergency input may be the actuation of a help button, or a predefined key sequence (e.g. *911) that indicates the user of the remote station is having a medical emergency. In other embodiments, the user may have a monitor that monitors one or more vital characteristics of the user and generates the emergency input of the remote station in the event that a characteristic indicative of a medical emergency is detected. The remote station, upon receipt of the emergency input, connects to an operator, as noted by block 354. The operator may attempt to verify and determine the nature of the medical emergency, if possible, and dispatches emergency medical personnel according to block 358. At block 362, the personal health record is provided to the emergency medical personnel. The personal health record may be provided in any of a number of ways, such as the operator accessing the personal health record and relaying this information to the medical personnel. The personal health record may also, upon dispatch of the operator, be provided to a display carried by the emergency medical personnel. In still other embodiments, the personal health record, upon activation of the emergency input at the remote station, be displayed at the remote station. In such a case, the emergency medical personnel may view this information on the remote station when they arrive to assist the user. In other embodiments, the operator may notify the emergency medical personnel that the personal health record will be displayed at the remote station. In this manner, the emergency medical personnel may have access to the personal health record without having to have any specialized equipment or stored biometric information to be authenticated. In still further embodiments, the personal health record can be displayed at the remote station protected by a one-time access code. Such a one-time access code may be sent to the emergency medical personnel by an operator as the emergency medical personnel travel to the scene. Once at the scene and in possession of the remote station, the emergency medical personnel may enter the one-time access code and view the personal health record.

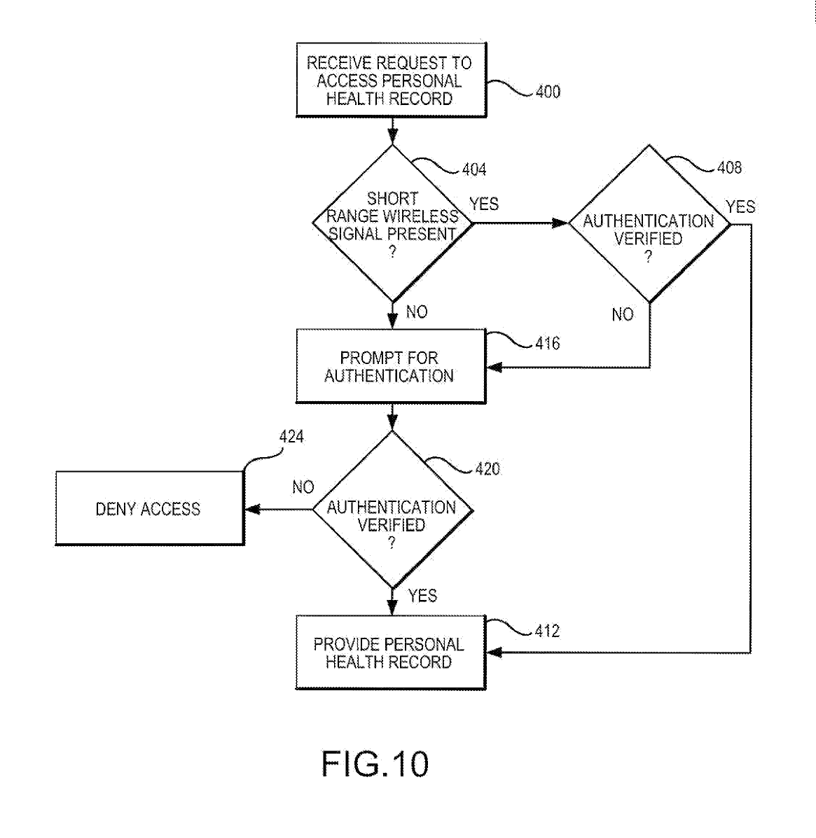

In other embodiments, the remote station may interface with other devices that are associated with and/or operated by individuals that are authorized, to access personal information. For example, an authorized individual may have an access device that may interface with the remote station. This individual may be authenticated through the access device, and their possession of this device provides the authorization that the remote station requires to provide access to the personal information of the user. In one exemplary embodiment, the authorized individual has a short range wireless, device, such as a BLUETOOTH device, that interfaces with a short range wireless component of the transmit/receive circuit of the remote station. The operational steps of this exemplary embodiment are illustrated in FIG. 10. The remote station, at block 400, receives a request to access a personal health record. At block 404, the remote station determines if a short range wireless signal is present. If such a signal is present, the remote station interfaces with the device transmitting the wireless signal and verifies the authentication of the individual requesting access to the personal information. If the authentication is verified, the personal health record is provided, as indicated at block 412. The personal health record may be provided by displaying the personal health record on the remote station, or the information may be transmitted over the wireless communication link to the device of the requestor. In the even that a short range wireless signal is not present, or if authentication is not verified through the short range wireless device, the remote station determines at block 420 if the authentication is verified. This verification may be accomplished using any of the previously described authentication techniques. If authentication is not verified at block 420, access to the personal health record is denied, at noted at block 424. Such an embodiment may be used, for example, in an emergency health care situation. In such a case, emergency health care providers may have a short range wireless device located in the immediate area where emergency health care services are provided. Such a location may be in an ambulance, at an emergency room, or carried on the person or mobile equipment of a health care provider. The short range wireless device may then transmit requests for the personal health record of the user, which is received by the remote station. The remote station may then complete the operations as described with respect to FIG. 10. In this manner, personal health information is provided to the emergency health provider in an automated fashion thus saving time and helping to ensure that the proper information is available to the health care provider.

In still further embodiments, the access to a personal health record may have a time limit that further protects privacy of the user. In such embodiments, when authentication and authorization have been completed, the personal health record is provided and a timer is started. When the timer expires, access to the personal health record is then discontinued. In this manner, personal information of the user is not displayed longer then the time limit, thus limiting the likelihood that an unauthorized person gains access to the personal information. In still further embodiments, each time the personal health record is accessed, a log of the access is kept that indicates the identification of the person accessing the record, and the time of the access. This log may then be accessed to verify that only authorized persons have accessed the personal information.

It is noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative, components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A remote station apparatus, comprising:
a transmit/receive circuit that is operable to transmit/receive signals to/from a wireless communications network;
a user interface; and
a control processor that authenticates and authorizes a request to access personal health information from said user interface, wherein said control processor provides said personal health information upon authentication and authorization.

2. The remote station apparatus, as claimed in claim 1, further comprising a memory, and wherein the personal information that is provided is stored in said memory.

3. The remote station apparatus, as claimed in claim 1, wherein said control processor connects to a server through said transmit/receive circuit and retrieves the personal health information that is stored at the server.

4. The remote station apparatus, as claimed in claim 1, wherein said control processor, upon receipt of the request to access personal health information, connects to a server through said transmit/receive circuit, authenticates the identify of the person making the request at the server, and obtains authorization from the server for the individual to access the personal health information.

5. The remote station apparatus, as claimed in claim 1, wherein said control processor is operable to receive an input from said user interface indicating an emergency, connect to a call center through said transmit/receive circuit, and provide the personal health information to the call center to provide to emergency response personnel.

6. The remote station apparatus, as claimed in claim 1, wherein the personal health information comprises at least one of a current prescription medication taken by the user and medical condition of the user.

7. The remote station apparatus, as claimed in claim 1, wherein said control processor is operable to execute instructions stored in a memory that provide prompts to said user interface and receives input from said user interface in response to said prompts, and wherein said personal health information is determined based on the input received from the user interface.

8. The remote station apparatus, as claimed in claim 1, wherein said authentication comprises a predefined sequence of inputs entered into said user interface.

9. The remote station apparatus, as claimed in claim 1, wherein said authentication comprises a biometric identification.

10. The remote station apparatus, as claimed in claim 9, further comprising a biometric sensor, and wherein said control processor compares biometric information provided by the biometric sensor to biometric information of an authorized user.

11. The remote station apparatus, as claimed in claim 9, further comprising a short range wireless transceiver that receives said authentication.

12. The remote station apparatus, as claimed in claim 1, wherein said control processor is further operable to receive a medical emergency notification from a monitor associated with the user of the remote station, connect to an emergency dispatch through said transmit/receive circuit, and provide said personal health information to emergency medical personnel.

13. The remote station apparatus, as claimed in claim 1, wherein after providing said personal health information, said control processor is further operable to start a timer and discontinue providing said personal health information upon expiration of said timer.

14. The remote station apparatus, as claimed in claim 1, wherein after providing said personal health information, said control processor is further operable to record art identification of a user that has been provided with said personal health record, and to provide the identified user with a single access to said personal health record within a preset time period.

15. A server apparatus, comprising:
a network interface to transmit/receive signals to/from at least a first wireless remote station through a wireless network;
a control processor operable to receive a request from said first remote station to access personal health information of a user of said first remote station, authenticate an identity of the individual requesting access, verify the individual is authorized to access the personal health information of the user, and provide the personal health information when the individual is authenticated and authorized.

16. The server apparatus, as claimed in claim 15, wherein said control processor is operable to receive biometric information of the individual requesting access and perform biometric identification of the individual.

17. The server apparatus, as claimed in claim 16, wherein said biometric information comprises at least one of hand geometry, retinal scan, iris scan, fingerprint patterns, facial characteristics, DNA sequence characteristics, voice prints, and hand written signature.

18. The server apparatus, as claimed in claim 15, wherein said personal health information comprises at least one of a current prescription medication taken by the user and a current medical condition of the user.

19. A wireless communication system, comprising:
a base station interconnected to a communications network;
a server interconnected to said communications network; and
a wireless remote station interconnected to said communications network through said base station;
wherein personal health information for a user of said remote station is stored at a memory of said server, and
wherein said remote station is operable to receive a request to access said personal health information, authenticate the identity of an individual requesting said personal health information, verify that the individual is authorized to access said personal health information, and provide said personal health information to the individual when the identity of the individual is authenticated and authorization is verified.

20. The wireless communication system, as claimed in claim 19, wherein the identity of the individual requesting said personal health information is authenticated using biometric identification.

21. The wireless communication system, as claimed in claim 20, wherein said biometric identification comprises identification of the individual from a measurement of one or more physical features or repeatable actions of the individual.

22. The wireless communication system, as claimed in claim 21, wherein said physical features or repeatable actions comprise at least one of: hand geometry, retinal scan, iris scan, fingerprint patterns, facial characteristics, DNA sequence characteristics, voice prints, and hand written signature.

23. The wireless communication system, as claimed in claim 19, wherein said remote station, upon receiving said request to access said personal health information: connects to said server through said base station and communications network, and provides biometric information of the individual requesting access to said personal health information to said server for authentication.

24. The wireless communication system, as claimed in claim 19, wherein said server is operable to prompt the user of the remote station to enter the personal health record.

25. The wireless communication system, as claimed in claim 19, wherein after providing said personal health information, said remote station is further operable to start a timer and discontinue providing said personal health information upon expiration of said timer.

26. The wireless communication system, as claimed in claim 19, wherein after providing said personal health information, said remote station is further operable to record an identification of a user that has been provided with said personal health record, and to provide the identified user with a single access to said personal health record within a preset time period.

27. A method for providing access to a personal health record through a wireless remote station, comprising:
receiving a request from an individual to access a personal health record of a user of the remote station;
authenticating the identity of the individual;
verifying the individual is authorized to access the personal health record; and
providing access to the personal health record when the individual's identity is authenticated and the authorization is verified.

28. The method, as claimed in claim 27, further comprising, after said step of receiving:
prompting the individual to provide biometric in formation; and
receiving the biometric information.

29. The method, as claimed in claim 28, wherein said step of authenticating comprises:
comparing the biometric information to known biometric information for the individual; and
authenticating the identity of the individual when the biometric information matches the known biometric information.

30. The method, as claimed in claim 29, wherein the biometric information comprises at least one of: hand geometry, retinal scan, iris scan, fingerprint patterns, facial characteristics, DNA sequence characteristics, voice prints, and hand written signature.

31. The method, as claimed in claim 27, wherein the individual is an emergency health care provider.

32. The method, as claimed in claim 27, wherein said step of providing comprises:
displaying said personal health record on a display of the remote station.

33. The method, as claimed in claim 32, wherein said step of providing further comprises:
discontinuing said displaying of said personal health record after a predetermined time period.

34. The method, as claimed in claim 27, further comprising:
logging said request for access, individual that requested access, and a date and time of said request.

35. A computer readable medium embodying a method for providing access to a personal health record through a wireless remote station, the method comprising:
receiving a request from an individual to access a personal health record of a user of the remote station;
authenticating the identity of the individual;
verifying the individual is authorized to access the personal health record; and
providing access to the personal health record when the individual's identity is authenticated and the authorization is verified.

36. The computer readable medium, as claimed in claim 35, wherein said method further comprises:
prompting the individual to provide biometric information; and
receiving the biometric information.

37. The computer readable medium, as claimed in claim 36, wherein said method further comprises:
comparing the biometric information to known biometric information for the individual; and
authenticating the identity of the individual when the biometric information matches the known biometric information.

38. The computer readable medium, as claimed in claim 36, wherein said biometric information comprises at least one of: hand geometry, retinal scan, iris scan, fingerprint patterns, facial characteristics, DNA sequence characteristics, voice prints, and hand written signature.

39. A wireless remote station apparatus, comprising;
means for wirelessly communicating with a base station;
means for receiving a request from an individual to access a personal health record of a user of the remote station;
means for authenticating the identity of the individual and verifying the individual is authorized to access the personal health record; and
means for providing access to the personal health record when the individual's identity is authenticated and the authorization is verified.

40. The remote station apparatus, as claimed in claim 39, further comprising:
means for prompting the individual to provide biometric information; and
means for receiving the biometric information.

41. The remote station apparatus, as claimed in claim 40, wherein said means for authenticating comprises:
means for comparing the biometric information to known biometric information for the individual; and
means for authenticating the identity of the individual when the biometric information matches the known biometric information.

42. The remote station apparatus, as claimed in claim 40, wherein the biometric information comprises at least one of: hand geometry, retinal scan, iris scan, fingerprint patterns, facial characteristics, DNA sequence characteristics, voice prints, and hand written signature.

43. A server apparatus, comprising:
means for receiving a request from an individual to access a personal health record of a user of a wireless remote station;
means for authenticating the identity of the individual and verifying the individual is authorized to access the personal health record; and
means for providing access to the personal health record when the individual's identity is authenticated and the authorization is verified.

44. The server apparatus, as claimed in claim 43, further comprising:
means for prompting the individual to provide biometric information; and
means for receiving the biometric information.

45. The server apparatus, as claimed in claim 44, wherein said means for authenticating comprises:
means for comparing the biometric information to known biometric information for the individual; and
means for authenticating the identity of the individual when the biometric information matches the known biometric information.

46. The server apparatus, as claimed in claim 44, wherein the biometric information comprises at least one of: hand geometry, retinal scan, iris scan, fingerprint patterns, facial characteristics, DNA sequence characteristics, voice prints, and hand written signature.
